(19) United States
(12) Patent Application Publication
(10) Pub. No.: US 2021/0354417 A1
(43) Pub. Date: Nov. 18, 2021

(54) BUNDLING OF SINGLE-USE PLASTICS INTO REUSABLE MATERIAL

(71) Applicants: Patrick B. McCullough, Niles, MI (US); Tyler A. McCullough, Granger, IN (US); Evan C. McCullough, Niles, MI (US)

(72) Inventors: Patrick B. McCullough, Niles, MI (US); Tyler A. McCullough, Granger, IN (US); Evan C. McCullough, Niles, MI (US)

(21) Appl. No.: 16/877,064

(22) Filed: May 18, 2020

(51) Int. Cl. B32B 3/20; B32B 37/12; B32B 38/00; B32B 27/08; B32B 7/12

(52) U.S. Cl. CPC B32B 3/20; B32B 37/12; B32B 38/00; B32B 27/08; B32B 2305/70; B32B 2038/0052; B32B 2307/304; B32B 2272/00; B32B 7/12

(57) ABSTRACT

Methods and apparatus are disclosed for bundling of single-use plastics into reusable material. An example method for forming a sheet of insulation includes arranging a plurality of single-use plastic straws to be parallel to each other in a side-by-side manner. At least some of the plurality of single-use plastic straws are arranged to contact adjacent ones of the plurality of single-use plastic straws. The example method also includes applying fastening material to the plurality of single-use plastic straws to couple the plurality of single-use plastic straws together.

### TECHNICAL FIELD

The present disclosure generally relates to single-use plastics and, more specifically, to bundling of single-use plastics into reusable material.

### BACKGROUND

Single-use products are used by many people on a daily basis. For instance, single-use plastic products are regularly used for drinking bottles, drinking cups, straws, lids, food wrappers, other food containers, grocery bags, other shopping bags, etc. Additionally, many single-use plastics are difficult and/or prohibitively expensive to recycle. As a result, much of the waste found in landfills, dumps, and/or the environment throughout the world derive from such single-use plastic products.

Currently, there is a push to reduce the amount of single-use plastic products being generated. For instance, many people use reusable grocery bags, coffee cups, water bottles, etc. to limit the demand for single-use plastic products. However, most plastics are not biodegradable. In turn, even if the world population were to stop generating any additional single-use plastic products, landfills would continue to be full of currently-existing single-use plastic products.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for bundling of single-use plastics into reusable material. An example disclosed sheet of insulation includes a plurality of single-use plastic straws aligned parallel to each other in a side-by-side manner. At least some of the plurality of single-use plastic straws contact adjacent ones of the plurality of single-use plastic straws. The example disclosed sheet of insulation also includes adhesive material coupling the plurality of single-use plastic straws together.

In some examples, the adhesive material includes tape extending longitudinally along a row of the plurality of single-use plastic straws. In some such examples, the adhesive material is applied to only one side of the row of the plurality of single-use plastic straws to increase flexibility of the sheet of insulation. In some examples, the adhesive material includes solidified adhesive liquid or paste.

In some examples, each of the plurality of single-use plastic straws includes a wall that extends between opposing ends to define a fluid path. In such examples, the ends of the plurality of single-use plastic straws are sealed to enclose the fluid paths. In some such examples, the sealed ends trap air within the enclosed fluid paths of the plurality of single-use plastic straws to increase insulation.

Some examples further include opposing outer layers between which the plurality of single-use plastic straws are disposed. In some such examples, the plurality of single-use plastic straws are arranged in a plurality of rows between the outer layers. In some such examples, the plurality of single-use plastic straws are arranged in a plurality of bundles between the outer layers.

An example disclosed method for forming a sheet of insulation includes arranging a plurality of single-use plastic straws to be parallel to each other in a side-by-side manner. At least some of the plurality of single-use plastic straws are arranged to contact adjacent ones of the plurality of single-use plastic straws. The example disclosed method also includes applying fastening material to the plurality of single-use plastic straws to couple the plurality of single-use plastic straws together.

In some examples, applying the fastening material includes applying tape longitudinally along a row of the plurality of single-use plastic straws. In some examples, applying the fastening material includes applying adhesive liquid or paste to the plurality of single-use plastic straws. In some examples, applying the fastening material includes sewing the plurality of single-use plastic straws together.

Some examples further include sealing ends of the plurality of single-use plastic straws to trap air within fluid paths of the plurality of single-use plastic straws for increased insulation. In some examples, sealing the ends of the plurality of single-use plastic straws includes tying the ends in knots. In some examples, sealing the ends of the plurality of single-use plastic straws includes melting the ends to heat seal the ends. Some such examples further include, to heat seal the ends of the plurality of single-use plastic straws, applying heat at a temperature between 240 degrees Fahrenheit and 340 degrees Fahrenheit to the ends of the of the plurality of single-use plastic straws.

Some examples further include positioning the plurality of single-use plastic straws between opposing outer layers of the sheet of insulation. Some such examples further include arranging the plurality of single-use plastic straws in rows or bundles between the outer layers of the sheet of insulation. Some such examples further include assembling a second plurality of single-use plastic straws together, positioning the plurality of single-use plastic straws in a first row between the outer layers of the sheet of insulation, and positioning the second plurality of single-use plastic straws in a second row between the outer layers of the sheet of insulation.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example sheet of plastic straws in accordance with the teachings herein when formed with tape.

FIG. 2 illustrates the sheet of plastic straws of FIG. 1 when formed with adhesive material.

FIG. 3 depicts an example straw of the sheet of plastic straws of FIG. 1 with open ends.

FIG. 4 depicts an example straw of the sheet of plastic straws of FIG. 1 with tied ends.

FIG. 5 depicts an example straw of the sheet of plastic straws of FIG. 1 with crimped ends.

FIG. 6 illustrates the sheet of plastic straws of FIG. 1 included in an example insulation layer in accordance with the teachings herein.

FIG. 7 illustrates the sheet of plastic straws of FIG. 1 included in an example insulation bundle in accordance with the teachings herein.

FIG. 8 illustrates the sheet of plastic straws of FIG. 1 included in an example bag in accordance with the teachings herein.

FIG. 9 illustrates the sheet of plastic straws of FIG. 1 included in an example table in accordance with the teachings herein.

FIG. 10 illustrates the sheet of plastic straws of FIG. 1 included in another example table in accordance with the teachings herein.

FIG. 11 illustrates the sheet of plastic straws of FIG. 1 included in an example chair in accordance with the teachings herein.

FIG. 12 is a flowchart for forming reusable articles from single-use straws in accordance with the teachings herein.

FIG. 13 illustrates an example container in accordance with the teachings herein.

FIG. 14 depicts single-use cups that form the container of FIG. 13.

FIG. 15 illustrates another example container in accordance with the teachings herein.

FIG. 16 depicts portions of single-use cups that form the container of FIG. 15.

FIG. 17 is a flowchart for forming a container from single-use cups in accordance with the teachings herein.

FIG. 18 illustrates a bumper in accordance with the teachings herein.

FIG. 19 depicts single-use lids and a tool that forms the bumper of insulation of FIG. 18.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example disclosed herein include commonly-used articles (e.g., insulation, bags, tables, chairs, planters, etc.) that are formed from and/or otherwise incorporate single-use plastics, such as straws, cups, and/or lids. In turn, the example methods and apparatus disclosed herein reduce the amount of waste generated from previously-used single-use plastics. As used herein, a “single-use” or “disposable” article refers to an article made of plastic and/or other material that was designed to be thrown away after being used only once. Example single-use or disposable articles are formed from polyethylene, polypropylene, and/or other plastics. Example single-use or disposable plastics include drinking bottles, drinking cups, straws, lids, food wrappers, other food containers, grocery bags, other shopping bags, etc.

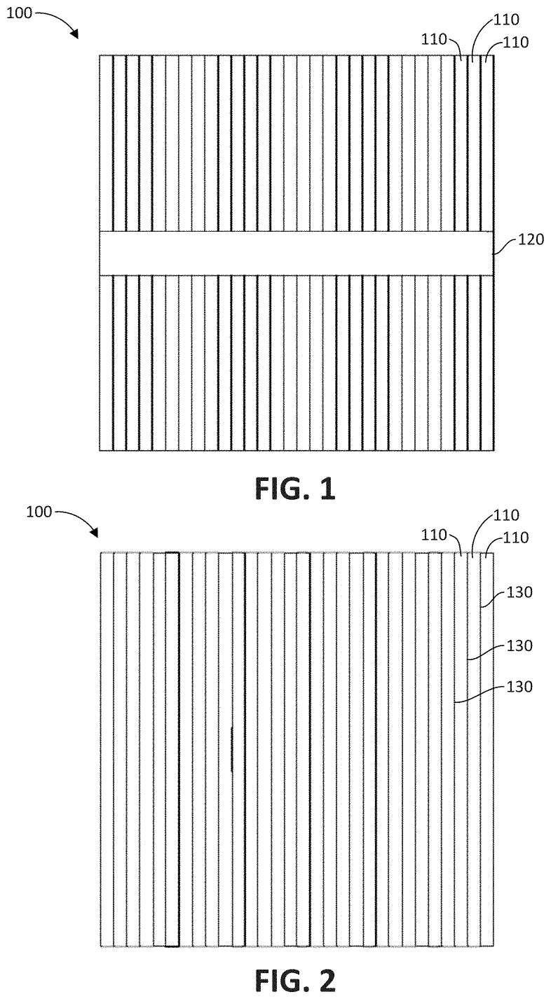

Turning to the figures, FIGS. 1-2 illustrates an example sheet 100 of straws 110 in accordance with the teachings herein. The straws 110 are single-use plastic straws. For example, the straws 110 are formed from polyethylene (e.g., polyethylene #2), polypropylene (e.g., polypropylene #5), and/or other plastic(s). Further, as shown in FIGS. 1-2, each of the straws 110 has a substantially uniform outer diameter and length. In other examples, one or more of the straws 110 may have a different outer diameter and/or length than others of the straws 110.

In FIGS. 1-2, the straws 110 are aligned in a row such that the straws 110 are parallel to each other in a side-by-side manner. In the illustrated example, one or more of the straws 110 are in contact with adjacent one(s) of the straws 110. For example, one of the straws 110 contacts another of the straws 110 that is directly adjacent on one side and/or another of the straws 110 that is directly adjacent on the opposing side.

In FIG. 1, the straws 110 are coupled together to form the sheet 100 via tape 120 with an adhesive layer. In the illustrated example, the tape 120 extends longitudinally along the row of the straws 110 that arranged in a side-by-side manner. In some examples, the tape 120 is applied to both sides of the row of the straws 110. In other examples, the tape 120 is applied to only one side of the row of the straws 110 to increase flexibility of the sheet 100.

In FIG. 2, the straws 110 are coupled together to form the sheet 100 via an adhesive liquid or paste 130 that solidifies upon being applied onto the straws 110. That is, the adhesive liquid or paste 130 is applied (e.g., sprayed) to the straws 110 in liquid or paste form and bonds the straws 110 together upon solidifying. Example adhesive includes epoxy and/or other form(s) of acrylic. In other examples, the straws 110 are coupled together to form the sheet 100 via other fastening material. For example, the straws 110 may be sewn together with thread.

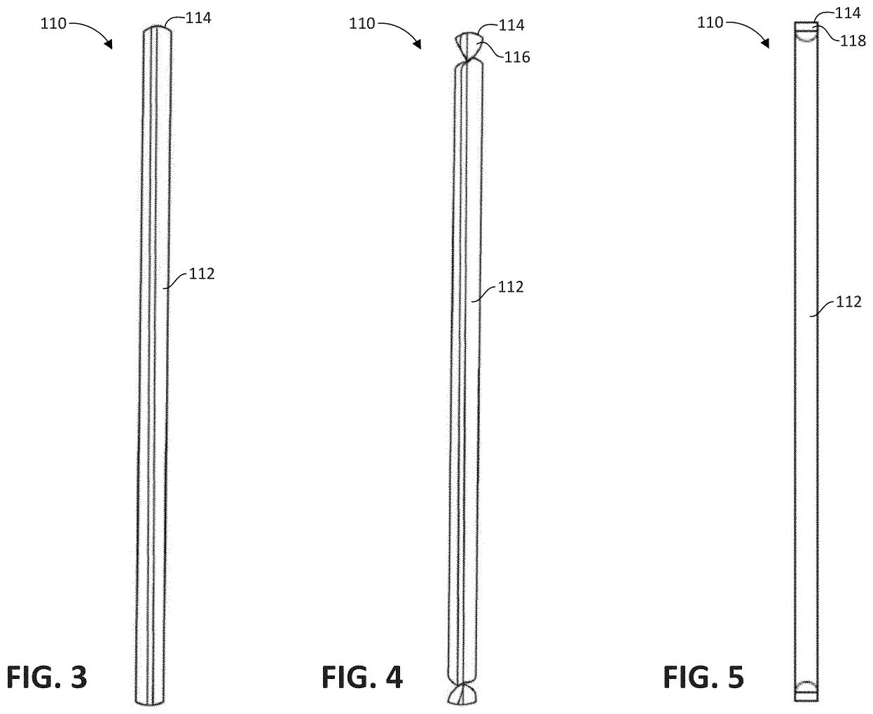

FIG. 3 depicts an example straw 110 in accordance with the teachings herein. The straw 110 includes a wall 112 that extends between opposing ends 114 of the straw 110 to define a fluid path. Each of the ends 114 defines an opening to the fluid path to enable fluid to travel through the straw 110.

FIGS. 4-5 depict examples in which the ends 114 of the straw 110 are sealed. For example, the ends 114 are sealed to enclose material (e.g., air, other insulating material, resin, etc.) within the fluid path of the straw 110. In FIG. 4, the ends 114 of the straw 110 are tied in knots 116 to seal the ends 114. In FIG. 5, the ends 114 of the straw 110 are heat-sealed ends 118. That is, each of the ends 114 is melted together to form a heat seal.

To form the heat-sealed ends 118, a tool (e.g., a heat sealer, an iron, a heat gun, etc.) applies heat locally to the ends 114. The temperature of the heat applied to form the heat-sealed ends 118 corresponds with the melting point of the single-use plastic that forms the straw 110. When the straw 110 is formed of a polyethylene plastic, the applied heat is between 240 degrees Fahrenheit and 275 degrees Fahrenheit. For example, the heat applied to the ends 114 of the straw 110 is about 266 degrees Fahrenheit when the straw 110 is formed of polyethylene #2. When the straw 110 is formed of a polypropylene plastic, the applied heat is between 266 degrees Fahrenheit and 340 degrees Fahrenheit. For example, the heat applied to the ends 114 of the straw 110 is about 338 degrees Fahrenheit when the straw 110 is formed of polypropylene #4. That is, when the straw 110 is formed of polyethylene and/or polypropylene, the heat applied to form the heat-sealed ends 118 is between 240 degrees Fahrenheit and 340 degrees Fahrenheit.

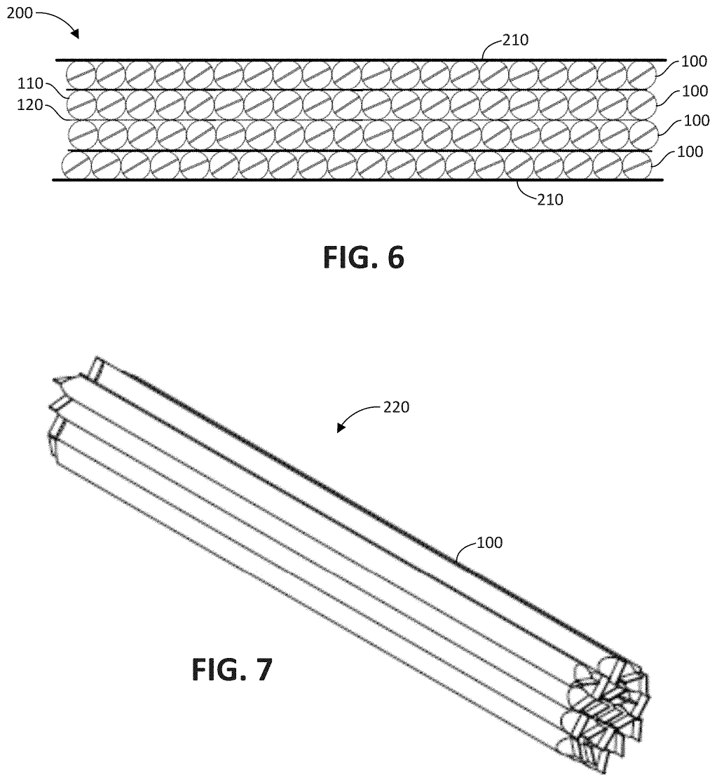

FIG. 6 depicts an example insulation sheet 200 in accordance with the teachings herein. As illustrated in FIG. 6, the insulation sheet 200 includes opposing outer layers 210 and one or more of the sheets 100. The straws 110 of the sheets 100 are positioned between the outer layers 210. That is, the sheets 100 of the straws 110 are contained within the outer layers 210 of the insulation sheet 200.

The straws 110 of the sheets 100 at least partially provide the insulation of the insulation sheet 200. In some examples, the outer layers 210 are formed of material that provides additional insulation. Further, in some examples, the straws 110 of the sheets 100 are sealed (e.g., via the knots 116 and/or the heat-sealed ends 118) to further increase the insulation provided by the straws 110. When the ends 114 of the straws 110 are sealed, any insulating material enclosed within the straws 110 further increases the insulating effect of the straws 110. In some examples, air is trapped within the fluid paths of the straws 110 to increase the provided insulation. In other examples, the straws 110 are filled with other insulating material to increase the provided insulation.

In FIG. 6, the sheets 100 of the straws 110 are arranged in rows between the outer layers 210 of the insulation sheet 200. In other examples, one of the sheets 100 is folded into a plurality of rows between the outer layers 210. Further, in other examples, the sheets 100 are arranged in other configurations between the outer layers 210. For example, the sheets 100 are capable of being arranged in bundles between the outer layers 210. FIG. 7 depicts an example bundle 220 that is formed by rolling one or more of the sheets 100 of the straws 110. In some examples, arranging the one or more sheets 100 in the bundle 220 increases the corresponding structural integrity. Further, in other examples, the insulation sheet 200 may be formed without the outer layers 210. That is, the sheets 100 of the straws 110 are capable of being arranged without the outer layers 210 in a manner that enables the sheets 100 to provide insulation.

The insulation sheet 200 is configured to provide insulation in variety of environments. The insulation sheet 200 may be used to insulate floor and/or sleeping mats, such as those provided to schoolchildren and/or displaced persons by governmental and/or non-profit agencies (e.g., the Federal Emergency Management Agency (FEMA) and/or other disaster relief agencies). The insulation sheet 200 may be used to insulate vehicles, such as a recreational towable. Additionally, the sheets 100 are capable of being used as material, such as packing material and/or wrapping material, that protects items when being shipped and/or stored.

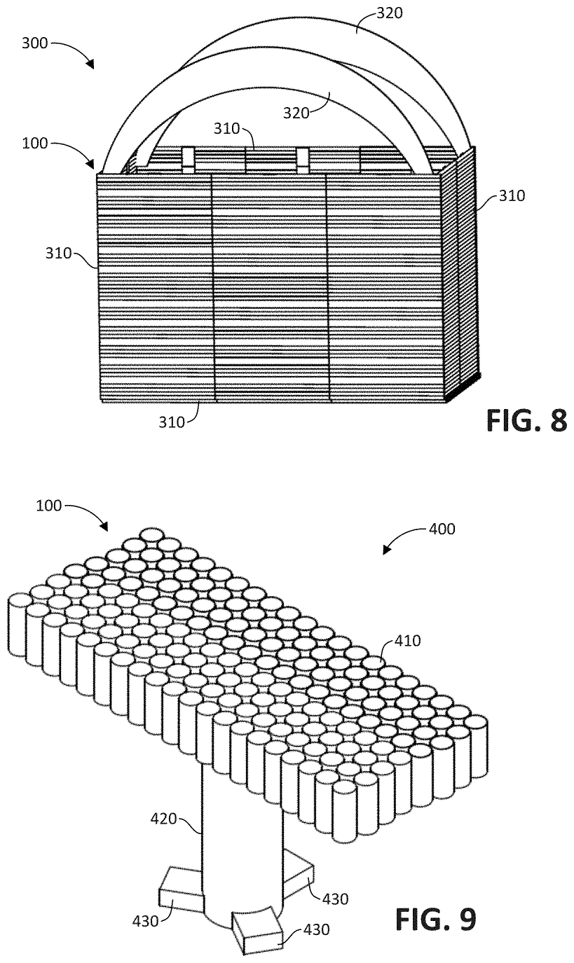

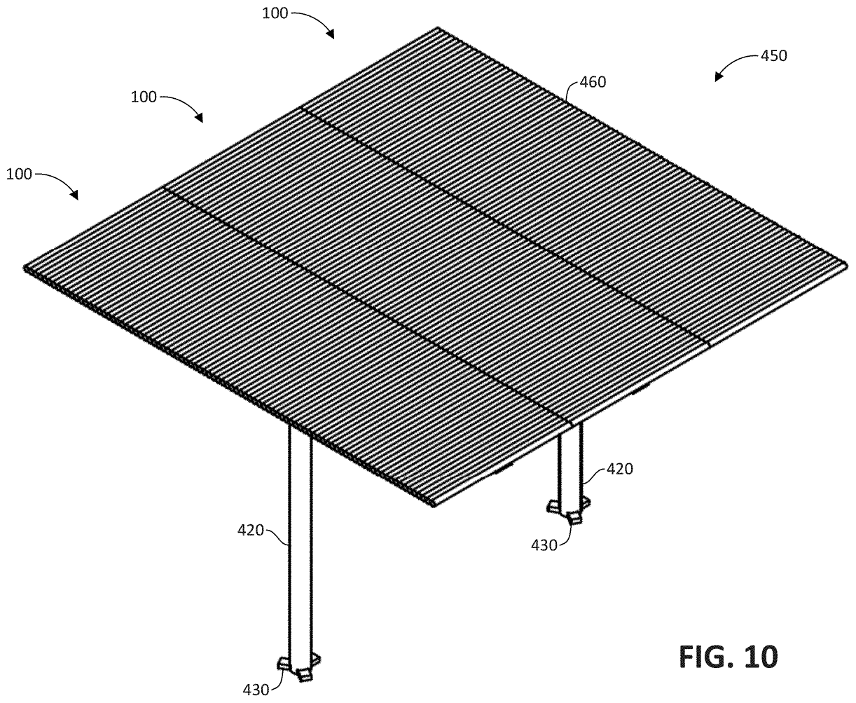

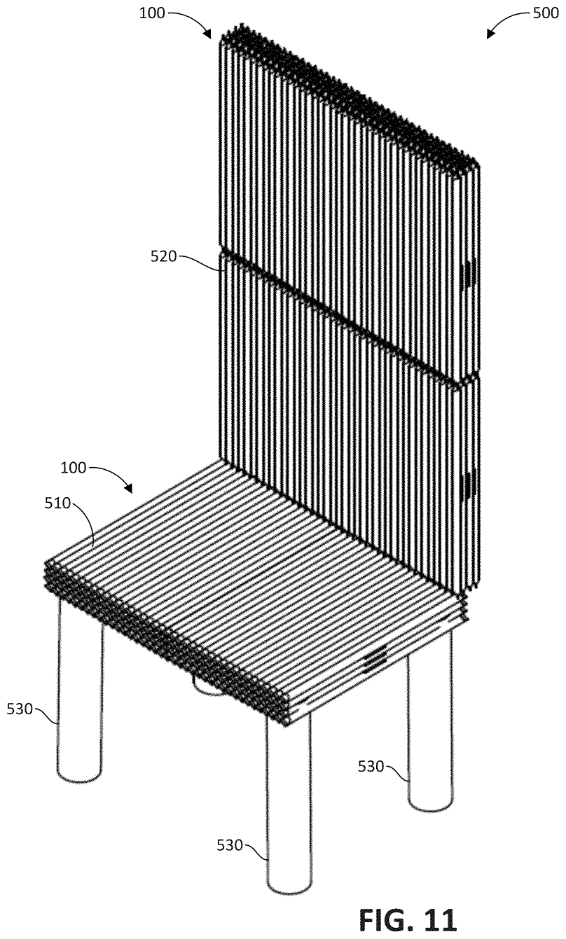

FIGS. 8-11 illustrate other example articles that are capable of being formed from one or more of the sheets 100 of the straws 110. More specifically, FIG. 8 depicts an example bag 300, FIG. 9 depicts an example table 400, FIG. 10 depicts another example table 450, and FIG. 11 depicts an example chair 500 in accordance with the teachings herein. Additionally, other articles, such as coasters or roll-up blinds, articles that are capable of being formed from one or more of the sheets 100 of the straws 110. For example, when one of the sheets 100 is configured to form a roll-up blind, cord(s) extend through the sheet 100 to enable a person to extend and/or retract the roll-up blind.

In FIG. 8, the bag 300 (e.g., a purse, a grocery bag, a beach bag, etc.) includes walls 310 that define the cavity of the bag 300 in which items are disposed. The walls 310 are formed from one or more of the sheets 100 of the straws 110. In the illustrated example, handles 320 are attached to the walls 310. In some examples, the handles 320 are formed from single-use material, such as single-use plastics, to further reduce the amount of single-use products that find their way into a landfill after a single use.

In FIG. 9, the table 400 includes a top 410 that is formed from one or more of the sheets 100 of the straws 110. In the illustrated example, the straws 110 are arranged vertically to form the top 410. In some examples, the straws 110 are filled with resin and/or other material to increase the sturdiness of the table 400. Additionally or alternatively, the straws 110 are trimmed to a length (e.g., between 1 inch and 1.5 inches) to increase the sturdiness of the top 400. Further, in some examples, an additional layer of material (e.g., a sheet of recycled glass, plastic, and/or other material) on top of the straws 110 to provide a uniformly flat surface.

The table 400 of the illustrated example also includes a leg 420 and feet 430. In other examples, the table 400 includes more or less legs and/or feet. Further, in some examples, the leg 420 and the feet 430 are formed from resin and/or other sturdy material. In other examples, the leg 420 and the feet 430 are formed from single-use material, such as single-use plastics, to further reduce the amount of single-use products that find their way into a landfill after a single use. Further, in other examples, the leg 420 and the feet 430 are from a preexisting table that is retrofitted with the top 410 formed from the straws 110 to further reduce the amount of generated waste.

In FIG. 10, the table 450 includes a top 460 that is formed from a plurality of the sheets 100 of the straws 110. In the illustrated example, the straws 110 are arranged horizontally to form the top 460. More specifically, the top 460 of the illustrated example is formed from a plurality of the sheets 100 that are arranged in rows that are parallel to each other. In some examples, the straws 110 are filled with resin and/or other material to increase the sturdiness of the table 450. Further, in some examples, an additional layer of material (e.g., a sheet of recycled glass, plastic, and/or other material) on top of the straws 110 to provide a uniformly flat surface.

In FIG. 11, the chair 500 includes a seat 510 and a back 520 that are formed from the sheets 100 of the straws 110. In the illustrated example, the straws 110 forming the back 520 are arranged vertically. In other examples, the straws 110 forming the back 520 may be arranged horizontally. Further, in some examples, the straws 110 are filled with resin and/or other material to increase the sturdiness and/or comfort of the chair 500. As illustrated in FIG. 10, the chair 500 also includes legs 530. In other examples, the chair 500 includes feet and/or a different number of legs. Further, in some examples, the legs 530 and/or feet are formed from single-use material, such as single-use plastics, to further reduce the amount of single-use products that find their way into a landfill after a single use.

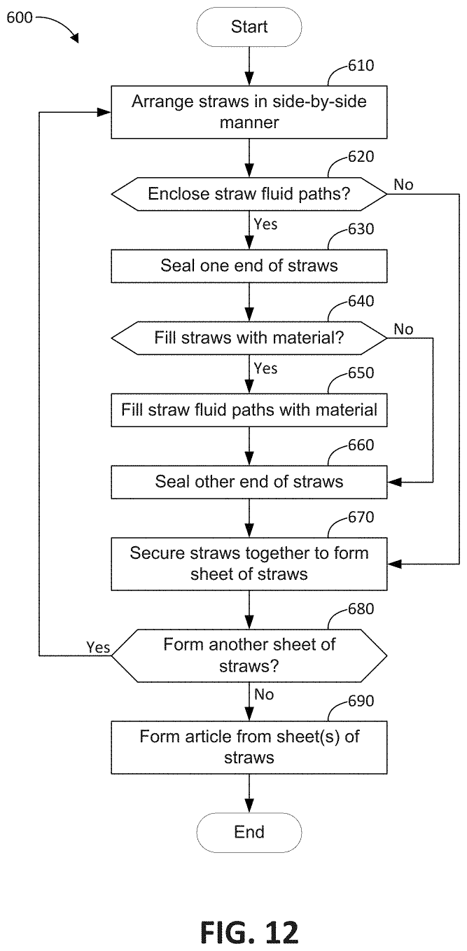

FIG. 12 is a flowchart of an example method 600 to form reusable articles (e.g., insulation, packing materials, bags, tables, chairs, etc.) from single-use straws. While the example method for forming articles from single-use straws is described with reference to the flowchart illustrated in FIG. 12, many other methods of forming articles from single-use straws may alternatively be used. For example, the order of execution of the blocks may be rearranged, changed, eliminated, and/or combined to perform the method 600. Further, because the method 600 is disclosed in connection with the components of FIGS. 1-11, some functions of those components will not be described in detail below.

Initially, at block 610, the straws 110 are arranged parallel to each other in a side-by-side manner. At block 620, it is determined whether to enclose the fluid paths of the straws 110. In response to determining that the fluid paths of the straws 110 are not to be enclosed, the method 600 proceeds to block 670. Otherwise, in response to determining that the fluid paths of the straws 110 are to be enclosed, the method 600 proceeds to block 630.

At block 630, one of the ends 114 of each of the straws 110 is sealed. For example, the ends 114 are tied in the knots 116 and/or the heat-sealed ends 118 are formed via heat sealing. At block 640, it is determined whether to fill the fluid paths of the straws 110 with material (e.g., resin, insulation material, etc.). In response to determining that the fluid paths of the straws 110 are not to be filled, the method 600 proceeds to block 660. Otherwise, in response to determining that the fluid paths of the straws 110 are to be filled, the method 600 proceeds to block 650 at which the fluid paths of the straws 110 are filled with material.

At block 660, the remaining ends 114 of the straws 110 are sealed (e.g., via the knots 116 and/or the heat-sealed ends 118). At block 670, the straws 110 are secured together to form the sheet 100 (e.g., a first sheet of straws). For example, the straws 110 are secured together via fastening material, such as the tape 120, the adhesive liquid or paste 130, sewing thread, etc.

At block 680, it is determined whether to form another sheet of straws. In response to determining that another sheet of straws (e.g., a second sheet of straws) is to be formed, the method 600 returns to block 610 to assemble the other sheet of straws. Otherwise, in response to determining that another sheet of straws is not to be formed, the method 600 proceeds to block 690 at which an article (e.g., an insulation sheet, packing material, a bag, a table, a chair, etc.) is formed from the one or more sheets 100 of the straws 110.

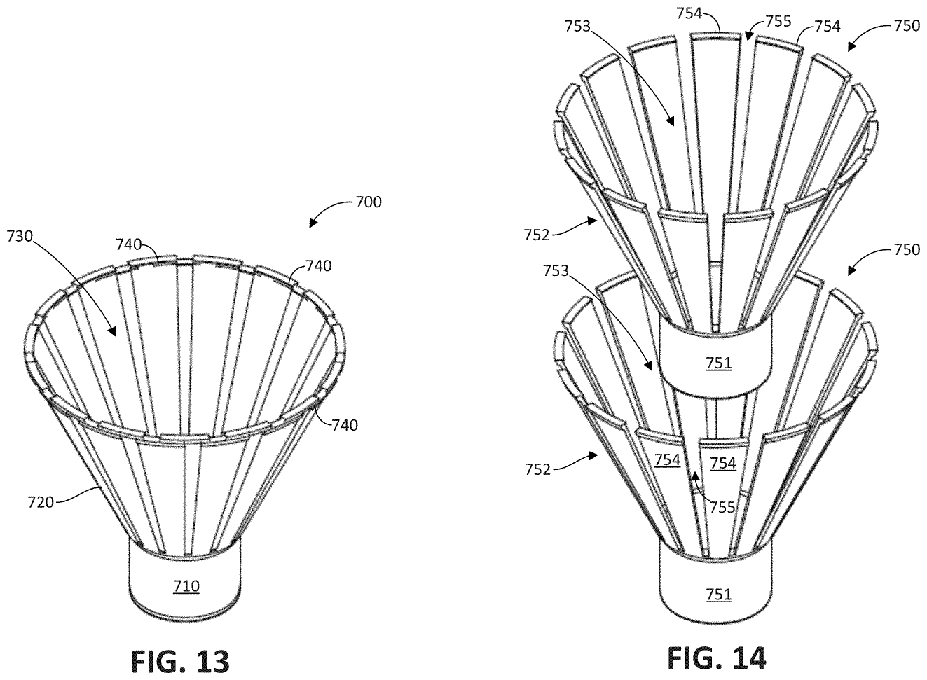

FIG. 13 illustrates an example container 700 in accordance with the teachings herein. For example, the container 700 (also referred to as a holding vessel) is capable of serving as a planter, a pot, a plant liner or insert, a desk organizer, and/or a container for other objects. As illustrated in FIG. 13, the container includes a base 710, a side wall 720 extending from the base 710, and a cavity 730 defined by the side wall 720 and/or the base 710. In the illustrated example, fastening material 740 (e.g., mechanical fasteners, tape, and/or other adhesive material) that are configured to at least partially form the side walls 720.

The container 700 of FIG. 13 is formed from single-use material, such as single-use plastics, to reduce the amount of single-use products that find their way into a landfill after a single use. For example, FIG. 14 depicts single-use cups 750 that are configured to form the container 700. Each of cups 750 includes a base 751 and a side wall 752 extending from the base 751. Additionally, for each of the cups 750, the base 751 and/or the side wall 752 defines a cavity 753. As illustrated in FIG. 14, the side walls 752 are cut into strips 754 with gaps 755 forming between the strips 754. For example, the gaps 755 between the strips 754 as a result of the strips 754 flexing slightly outward in a radial manner upon the side wall 752 being cut to form the strips 754. In the illustrated example, the strips 754 are vertical. In other examples, the strips 754 may be helical and/or any other shape that extends from the base 751 to an upper lip of the respective cup 750.

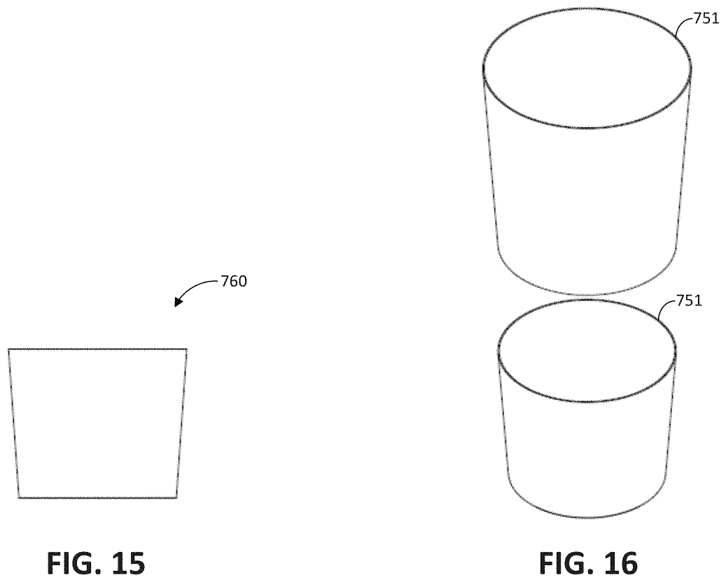

FIG. 15 illustrates an example container 760 in accordance with the teachings herein. For example, the container 760 (also referred to as a holding vessel) is capable of serving as a seeding container for nurseries, greenhouses and/or other facilities at which plants are grown. As illustrated in FIG. 16, the container 760 is formed from the base 751 of one or more of the cups 750. For example, to form the container 760 of FIG. 15, a horizontal cut is made along the base 751 of each of the cups 750, the base 751 is removed from the other portion of the cup 750, and the base 751 of one of the cups 750 is subsequently placed within the opening of the base 751 of the other of the cups 750.

Additionally, the cups 750 are capable of forming other articles. For example, the cups 750 are capable of forming lamp shades and/or other articles that have a truncated conical shape.

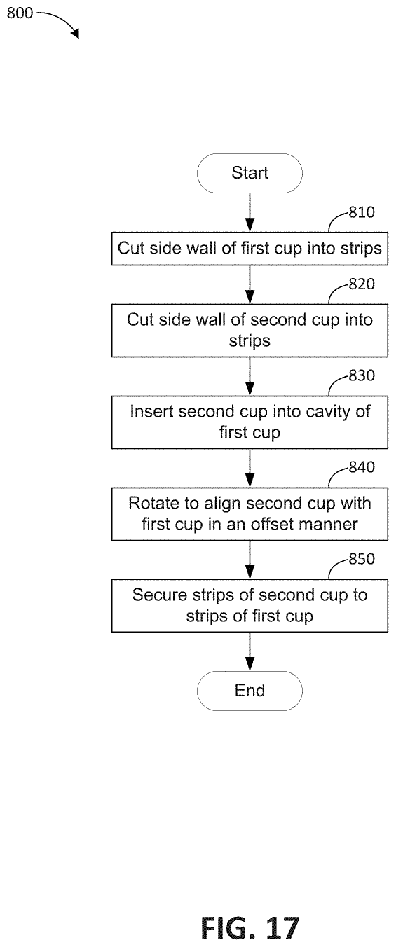

FIG. 17 is a flowchart of an example method 800 for forming the container 700 from the single-use cups 750. While the example method for forming the container 700 is described with reference to the flowchart illustrated in FIG. 17, many other methods for forming the container 700 from single-use plastics may alternatively be used. For example, the order of execution of the blocks may be rearranged, changed, eliminated, and/or combined to perform the method 800. Additionally, similar methods may be used to form the container 760 from single-use plastics. Further, because the method 800 is disclosed in connection with the components of FIGS. 13-14, some functions of those components will not be described in detail below.

Initially, at block 810, the side wall 752 of a first of the cups 750 is cut to form the strips 754. At block 820, the side wall 752 of a second of the cups 750 is cut to form the strips 754. At block 830, the second of the cups 750 is placed in the cavity 753 of the first of the cups 750. Alternatively, the first of the cups 750 is placed in the cavity 753 of the second of the cups 750. At block 840, the first and second of the cups 750 are rotated with respect to each such that the strips 754 of the first of the cups 750 is offset with the strips 754 of the second of the cups 750. As illustrated in FIG. 14, each of the strips 754 of the second of the cups 750 (1) overlaps with the adjacent strips 754 of the first of the cups 750 and (2) covers the gap 755 formed between the adjacent strips 754 of the first of the cups 750. The strips 754 of the cups 750 are arranged in the offset manner to form the side wall 720 of the container 700. For example, each of the gaps 755 of one of the cups 750 is covered by an adjacent one of the strips 754 of the other of the cups 750 such that the side wall 720 of the container 700 is continuous without any gaps. Returning to method 800 of FIG. 17, at block 850, the strips 754 of the second of the cups 750 are secured to the strips 754 of the first of the cups 750 via the fastening material 740.

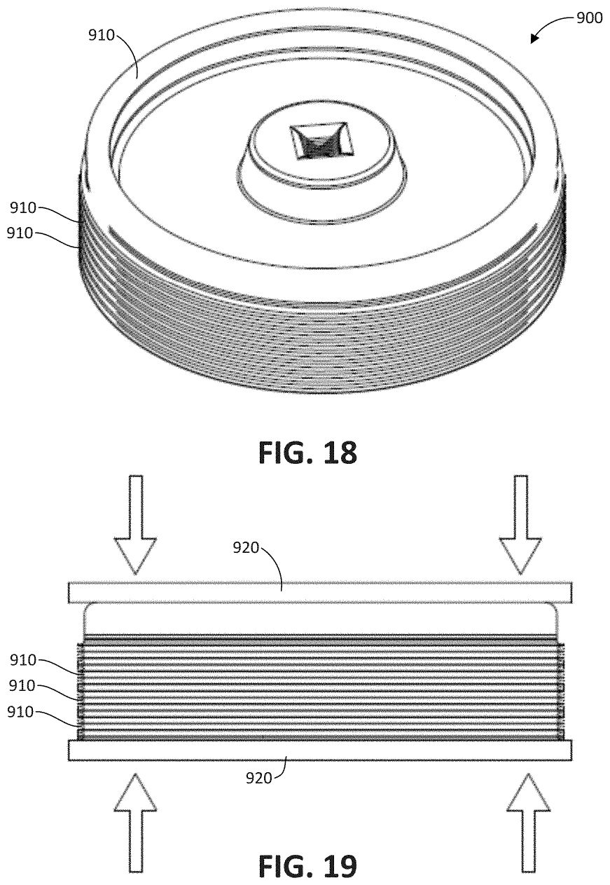

FIG. 18 illustrates an example bumper 900 in accordance with the teachings herein. For example, the bumper 900 may be installed on and/or adjacent a dock and function as a boat bumper. The bumper 900 is formed is formed from single-use material, such as single-use plastics, to reduce the amount of single-use products that find their way into a landfill after a single use. As illustrated in FIG. 18, the bumper 900 includes a stack of single-use lids 910 (e.g., drinking-cup lids) that are pressed together.

To form the bumper 900, as illustrated in FIG. 19, the stack of the lids 910 are positioned within a tool 920 (e.g., a vice). The tool 920 applies a force onto the lids 910 to compress the lids 910 and press the stack of the lids 910 together. Additionally, upon being pressed together via the tool 920, the lids 910 are secured together via fastening material, such as mechanical fasteners, tape, other adhesive, thread, etc.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A sheet of insulation, comprising:
a plurality of single-use plastic straws aligned parallel to each other in a side-by-side manner, wherein at least some of the plurality of single-use plastic straws contact adjacent ones of the plurality of single-use plastic straws; and
adhesive material coupling the plurality of single-use plastic straws together.

2. The sheet of insulation of claim 1, wherein the adhesive material includes tape extending longitudinally along a row of the plurality of single-use plastic straws.

3. The sheet of insulation of claim 2, wherein the adhesive material is applied to only one side of the row of the plurality of single-use plastic straws to increase flexibility of the sheet of insulation.

4. The sheet of insulation of claim 1, wherein the adhesive material includes solidified adhesive liquid or paste.

5. The sheet of insulation of claim 1, wherein each of the plurality of single-use plastic straws includes a wall that extends between opposing ends to define a fluid path, wherein the ends of the plurality of single-use plastic straws are sealed to enclose the fluid paths.

6. The sheet of insulation of claim 5, wherein the sealed ends trap air within the enclosed fluid paths of the plurality of single-use plastic straws to increase insulation.

7. The sheet of insulation of claim 1, further comprising opposing outer layers between which the plurality of single-use plastic straws are disposed.

8. The sheet of insulation of claim 7, wherein the plurality of single-use plastic straws are arranged in a plurality of rows between the outer layers.

9. The sheet of insulation of claim 7, wherein the plurality of single-use plastic straws are arranged in a plurality of bundles between the outer layers.

10. A method for forming a sheet of insulation, the method comprising:
arranging a plurality of single-use plastic straws to be parallel to each other in a side-by-side manner, wherein at least some of the plurality of single-use plastic straws are arranged to contact adjacent ones of the plurality of single-use plastic straws; and
applying fastening material to the plurality of single-use plastic straws to couple the plurality of single-use plastic straws together.

11. The method of claim 10, wherein applying the fastening material includes applying tape longitudinally along a row of the plurality of single-use plastic straws.

12. The method of claim 10, wherein applying the fastening material includes applying adhesive liquid or paste to the plurality of single-use plastic straws.

13. The method of claim 10, wherein applying the fastening material includes sewing the plurality of single-use plastic straws together.

14. The method of claim 10, further comprising sealing ends of the plurality of single-use plastic straws to trap air within fluid paths of the plurality of single-use plastic straws for increased insulation.

15. The method of claim 14, wherein sealing the ends of the plurality of single-use plastic straws includes tying the ends in knots.

16. The method of claim 14, wherein sealing the ends of the plurality of single-use plastic straws includes melting the ends to heat seal the ends.

17. The method of claim 16, further comprising, to heat seal the ends of the plurality of single-use plastic straws, applying heat at a temperature between 240 degrees Fahrenheit and 340 degrees Fahrenheit to the ends of the of the plurality of single-use plastic straws.

18. The method of claim 10, further comprising positioning the plurality of single-use plastic straws between opposing outer layers of the sheet of insulation.

19. The method of claim 18, further comprising arranging the plurality of single-use plastic straws in rows or bundles between the outer layers of the sheet of insulation.

20. The method of claim 18, further comprising:
assembling a second plurality of single-use plastic straws together;
positioning the plurality of single-use plastic straws in a first row between the outer layers of the sheet of insulation; and
positioning the second plurality of single-use plastic straws in a second row between the outer layers of the sheet of insulation.
